(19) United States
(12) Patent Application Publication
(10) Pub. No.: US 2007/0106907 A1
(43) Pub. Date: May 10, 2007

(54) Method and device for encryption and decryption on the fly

(75) Inventors: Stephane Rainsard, Louveciennes (FR); Cyrille Pepin, Louveciennes (FR)

Correspondence Address: OSHA LIANG L.L.P., 1221 MCKINNEY STREET, SUITE 2800, HOUSTON, TX, 77010, US

(73) Assignee: AXALTO S.A., Meudon (FR)

(21) Appl. No.: 10/581,838

(22) PCT Filed: Dec. 2, 2004
(86) PCT No.: PCT/IB04/03984

§ 371 Date: Jun. 5, 2006

(30) Foreign Application Priority Data
Dec. 4, 2003 (EP) 03293035.6

(51) Int. Cl. H04K 1/06; G06F 12/14; H04K 1/04; H04L 9/32; G06F 11/30

(52) U.S. Cl. 713/189; 380/37

(57) ABSTRACT

A method for protecting a datum, wherein the datum is encrypted and, prior to sending the datum to a recipient, the datum is divided into at least a first block and a second block. The method includes receiving, at the recipient, the first block; decrypting the first block to obtain a decrypted first block, re-encrypting the decrypted first block to obtain a re-encrypted first block using an encryption algorithm, prior to decrypting the second block, receiving, at the recipient, the second block, decrypting the second block to obtain a decrypted second block; and re-encrypting the decrypted second block to obtain a re-encrypted second block using the encryption algorithm, wherein the first block and the second block are transmitted individually to the recipient.

### TECHNICAL FIELD

This invention concerns a method and a device to secure an electronic assembly implementing a program using confidential data to be protected. More precisely, the purpose of the method is to propose a defence to protect said data during sensitive operations carried out in several steps. The breakdown into successive steps of sensitive operations may make said data vulnerable to some attacks. The term attack is understood to be any means or device used to recover the data between each operation by modifying the execution (non execution or incorrect execution) of all or part of the program, for example.

A problem caused by this invention is the vulnerability of confidential data likely to be found by attacks on the electronic assembly handling it.

Another problem caused is the reception of said data in several steps. At each step all or some of said data is transmitted to the electronic assembly, which increases its vulnerability.

The purpose of this invention is to minimise the vulnerability of the data processed in an electronic assembly.

There is a price to be paid in setting up such a security mechanism (in terms of time, scale and/or complexity of the mechanism, etc.). The purpose of this invention is to offer a safe and inexpensive solution.

### SUMMARY OF THE INVENTION

This invention concerns a method to ensure the security of encrypted data transmitted in blocks to an electronic assembly in several steps characterised in that it consists, when said assembly receives a block, in decrypting the block received, processing the information contained in said block and in encrypting the information processed.

This invention also concerns a device to ensure the security of an electronic assembly, the electronic assembly as such and the program executing the steps in the method.

### BRIEF DESCRIPTION OF THE DRAWINGS

Other purposes, features and advantages of the invention will appear on reading the description which follows of the implementation of the method according to the invention and of a mode of realisation of an electronic system designed for this implementation, given as a non-limiting example, and referring to the attached drawings in which:

FIG. 1 is a diagram illustrating the various steps of one form of realisation of the method according to the invention;

FIG. 2 is a diagrammatic representation of a normal method to process data received in several steps in an electronic assembly without implementing the device according to this invention, the assembly suffering no attack;

FIG. 3 is a diagrammatic representation of a normal method to process data received in several steps in an electronic assembly without implementing the device according to this invention and in the presence of an attack;

FIG. 4 is a diagrammatic representation of the security method according to this invention in an electronic assembly suffering no attack;

FIG. 5 is a diagrammatic representation of the security method according to this invention in an electronic assembly suffering attack;

FIGS. 6, 7 and 8 show diagrammatically the useful information of various data blocks likely to be received by an electronic assembly;

FIG. 9 represents an example of data transmitted to an electronic assembly as blocks;

FIGS. 10 to 12 give a diagrammatic representation, according to an example of data reception in three steps, of the various phases of one form of realisation of the method according to this invention represented on FIG. 1;

FIG. 13 is a diagram illustrating the various steps of another form of realisation of the method according to the invention;

FIGS. 14 and 15 give a diagrammatic representation, according to an example of data reception of which only two steps have been illustrated, of the various phases of the form of realisation of the method according to this invention represented on FIG. 13.

### WAY OF REALISING THE INVENTION

The objective of the method according to the invention is to secure a system and more precisely an electronic assembly and, for example, a portable object such as a smart card which uses sensitive encrypted data transmitted to the assembly in several steps. The electronic assembly includes information processing means such as a processor and information storage means such as a memory.

As a non-limiting example, the electronic assembly described below corresponds to a portable object comprising an electronic module. This type of module is generally realised as a monolithic integrated electronic microcircuit, or chip, which once physically protected by any known means can be assembled on a portable object such as for example a smart card, integrated circuit card or other card which can be used in various fields.

The microprocessor electronic module comprises, for example, a microprocessor CPU with a two-way connection via an internal bus to a non volatile memory of type ROM, EEPROM, Flash, FeRam or other containing a program to be executed, a volatile memory of type RAM, input/output means I/O to communicate with the exterior.

According to an example of this invention, the card is a smart card equipped with information processing and storage means, including a functional module known under the abbreviation “SIM” (Subscriber Identity Module). The SIM card communicates and exchanges data with its host terminal, the mobile telephone, the telephone sending commands which the SIM card must answer. These commands are formatted according to the APDU (Application Protocol Data Unit) and allow, amongst other things, data transfer. The APDU commands may be chained commands and can transfer data in several transmissions.

According to another example, the card is a bank card receiving chained APDU commands.

This invention applies to any type of card likely to receive sensitive data as chained commands transferred in several transmissions.

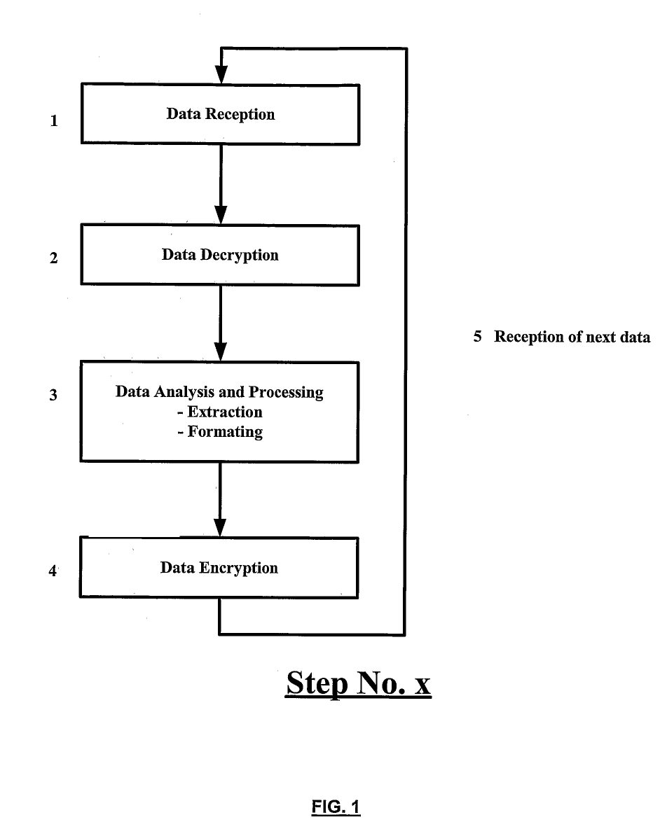

This invention concerns the handling of sensitive data such as, for example, keys received by said system in several transmissions. As shown on FIG. 1, phase 1 of the method therefore consists in receiving some of this data. The security method according to this invention ensures the confidentiality of this data upon reception by encrypting it (phase 4, FIG. 1) after decrypting it (phase 2, FIG. 1), analysing and processing it (phase 3, FIG. 1). The encrypted data is added to the encrypted data of the previous block received (concatenation of encrypted data). According to one form of realisation, the data is decrypted, analysed and processed, encrypted before processing the next block received.

The data received are first decrypted then encrypted internally in the device.

The method according to this invention consists in extracting and analysing before encryption, but upon reception, all the information contained in the data required to continue the processing and in using the extracted information to format the data in its final form. The data received is formatted for future use. Protecting the data in this way must not make it more difficult to use. The data may have to be formatted before it is secured. Formatting may consist, for example, in adding padding, inverting the data or deleting unnecessary information, etc.

The method according to this invention is used to extract and handle the data at each reception step, thereby limiting the time to process and handle the sensitive data.

According to one form of realisation, the attacks are made more difficult since the processing operations (formatting, encryption, etc.) are carried out before receiving the next data (phase 5). All or some of the data received is therefore protected before continuing the process.

Encryption is an additional protection to “scrambled” writing. Some devices can “scramble” the memory, i.e. encrypt it. With this feature, the data stored in memory still has to be encrypted, however. This “scramble” mechanism stops the data from being read from the outside but not from being “diverted” from an internal read routine. The additional encryption may also prove to be more robust.

A priori, not all the information required for the data processing (for the formatting, in particular) is known. Various items of information must be extracted “on the fly” during processing. Data encryption will therefore depend on the data analysis which will be carried out when the data is received and processed.

Firstly, the principle of the method according to the invention is described for each processing step. Secondly, the mechanisms set up, what they provide and what makes them different from existing mechanisms, will be developed and explained.

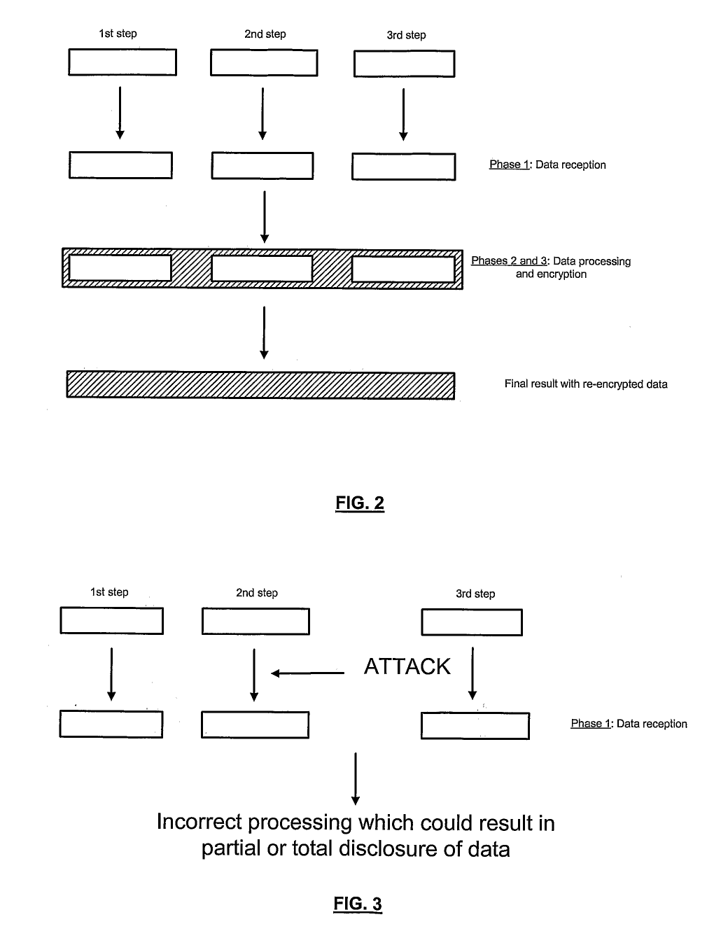

In FIGS. 2 to 5, 9 to 12, 14 and 15, the black rectangles designate the data blocks received and the hatched rectangles the blocks of re-encrypted data.

As shown on FIG. 2, the data is transmitted in segments. In each step (1^{st}, 2^{nd} and 3^{rd} steps on FIG. 2), the electronic assembly receives some of the data. The known data processing method in an electronic assembly comprises the following phases:
Phase 1: Data reception.
Phase 2: Data processing.
Phase 3: Data encryption.

FIG. 2 demonstrates the fact that the data processing and encryption are only carried out when all the data has been received, i.e. after the third data reception step.

FIG. 3 illustrates the vulnerability of the data when an electronic assembly not equipped with a device according to this invention is attacked.

Each phase takes place according to the diagram of FIG. 2. During data reception in the 2^{nd} step, however, the electronic assembly is attacked. The attack may result either in incorrect processing or an interruption in the data processing. Generally, incorrect processing may allow partial or total disclosure of the data during this processing or during the future use of the data.

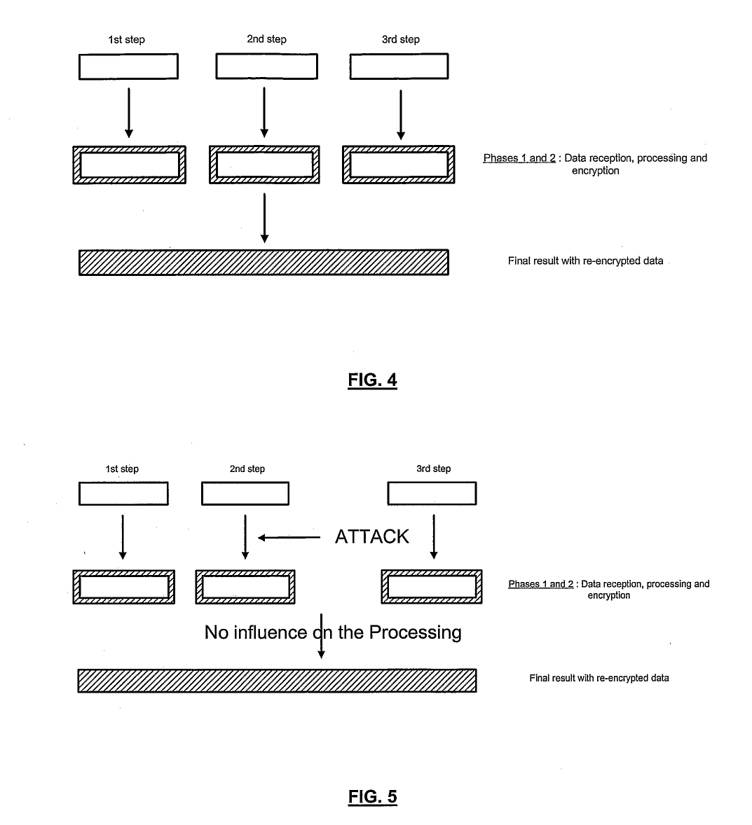

To overcome this problem, the electronic assembly is equipped with a device according to this invention. The data processing method according to one form of realisation of the invention is shown on FIG. 4. In each step, upon receiving the data, said data is processed (i.e. extraction phase, formatting, etc.) and immediately re-encrypted. In this case, we have only one phase which corresponds to the entire mechanism.

FIG. 5 demonstrates the advantages provided by the method according to this invention when faced with an attack during the second step. The attack fails to obtain information about the processed data, since this data was immediately re-encrypted in the first and second steps. The attack has no impact on the data processing and does not interrupt correct execution of the application.

Numerous constraints may arise due to the fact that the data is received in successive sets. For example, according to the algorithm used for decryption or encryption, additional problems may occur.

The problems encountered and then the solution provided by this invention are described below.

The following additional problems may be encountered:
the data from the reception of successive data groups, e.g. by chained APDU, is segmented: the size of each of these data groups, however, does not necessarily correspond to the size of the blocks processed by the encryption algorithm used internally by the electronic assembly;
some of the data received will not be kept, since it is only required for the formatting of this data; according to this invention, the useful information is extracted before processing starts;
the format of the input data involves different lengths;
the hardware implementation of a particular mechanism (in this case RSA) may involve special processing operations;
the encryption algorithms used internally may require a padding calculation: padding consists in adding one or more bits to a message so that the message contains a constant multiple of the number of bits required by a cryptographic algorithm.

These points are described in more detail below.

The first point concerns the segmentation of the data received, imposed by the cryptographic algorithm used.

The data received is encrypted. In the first data processing carried out by the cryptographic algorithm used (the Triple DES algorithm in the example described), the data must be handled in blocks of 8 bytes. During each data reception, however, (e.g. reception of chained commands) the sets of data received (each APDU received) comprise x block(s) of 8 bytes (x ranges from 0 to 32), and x residual byte(s). This breakdown in input is known as segmentation; each unit of this breakdown is known as a segment. This segmentation is not related to the steps but corresponds in our example to an additional breakdown.

The second point concerns the presence of useful and non-useful data.

During the reception of each data block, said block is decrypted then processed. Within each data block, not all of the data is necessarily useful. The data which will not be re-encrypted is considered as non-useful. As a non-limiting example, during the reception of an encrypted message, the parts corresponding to a tag, a length, a header and/or padding are considered as non-useful data.

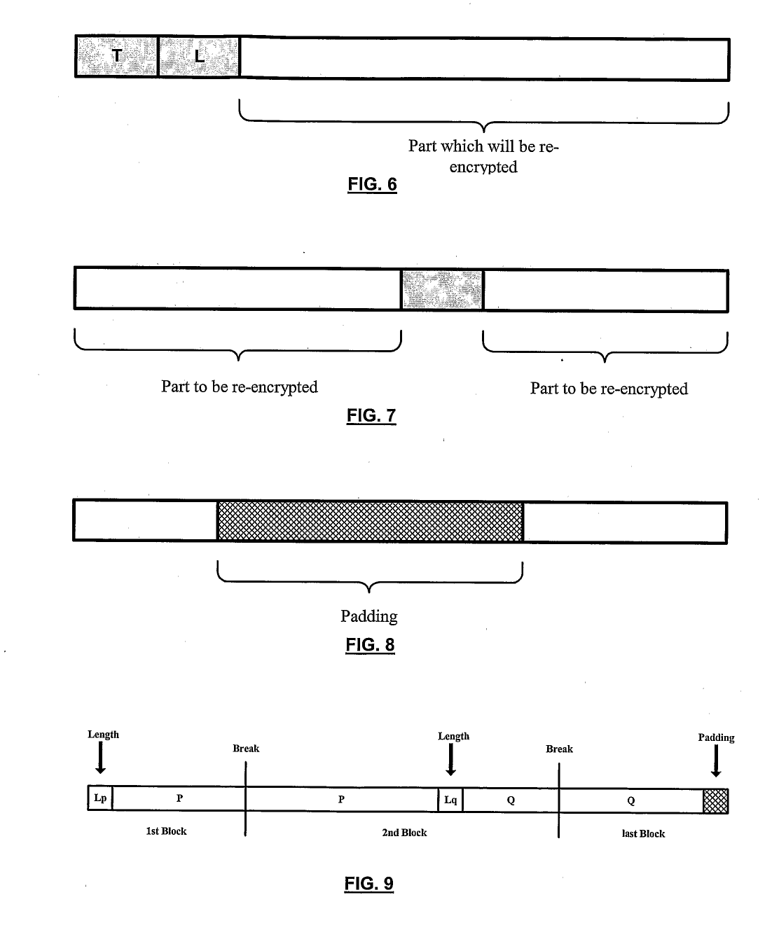

According to a first example illustrated on FIG. 6, during the reception of a block, the parts corresponding respectively to tag (T) and to length (L) are not considered as useful data. According to this invention, during encryption, this data will not be taken into account.

According to a second example illustrated on FIG. 7, during the reception of chained commands, a “non-useful” part may appear in the middle of a block. According to this invention, during encryption, this part is not taken into account.

According to a third example illustrated on FIG. 8, during data reception, the data may include padding (for example, so that the number of data bytes is a multiple of 8). The padding may be in the middle of the data but more generally at the end of the data (these two types of padding may be combined). According to this invention, during encryption, the padding is not taken into account.

The third point concerns the variable lengths of the data received.

During block reception(s), the length of the data to be decrypted and the length of the data to be encrypted are not necessarily known. With a key for example, the total length of the data may be known, but not the length of each element forming the key (P, Q, dP, dQ and PQ).

The fourth point concerns the hardware implementation used which requires special processing operations.

With the hardware implementation of the RSA algorithm used, it may be necessary to invert the most significant (MS) and the least significant (LS) bits during data encryption. This processing is carried out before data encryption.

The fifth point concerns the problem of the padding bits. The number of padding bits to be added to the data received may have to be calculated before re-encrypting the data, depending on the encryption algorithm used.

In conclusion, all these problems and constraints can be combined together. They involve handling operations which are costly in terms of time, code and memory space. In addition, the data which is decrypted then re-encrypted must remain unencrypted for as little time as possible to minimise its vulnerability to attack.

The problem is to be able to manage and reduce the above constraints in order to optimise the time to process the sensitive data and secure the mechanisms implemented.

The method according to this invention in a first form of realisation is described below.

As shown on FIG. 9, the data is received in segments (three segments in the example illustrated) separated by a break. The segments have variable lengths and corisist of “useful” and “non-useful” data. In this case, the length and the padding are non-useful data. A block consists of all the data received during each step.

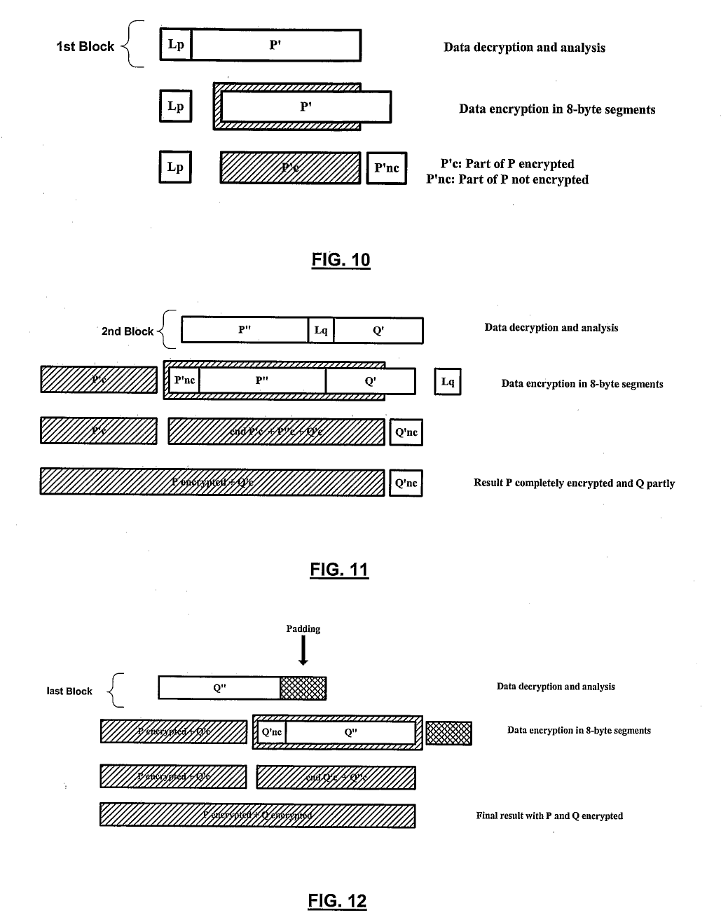

According to the method of this invention and as illustrated on FIG. 10, when the first block is received, the data is decrypted and analysed. The length Lp representing the non-useful data is extracted from the data block received. The resulting useful data is encrypted in 8-byte segments (P′c), this segmentation being imposed by the encryption algorithm used in this example. The result is a set P′nc of less than 8 bytes, which can therefore not form an 8-byte segment required for encryption.

At the end of the first step, the processing of the first block leads to a length Lp extracted and not encrypted, to a set of encrypted 8-byte segments P′c and to a set of less than 8 bytes not encrypted P′nc.

The reception and processing of the second block are represented on FIG. 11. As seen previously, the second block consists of a set of bits P″ and of another set Q′ separated by a length Lq. According to the method of the invention, the data is therefore decrypted. After analysing the data, the length Lq is extracted from the decrypted block received. The resulting data to which is added the set P′nc of the previous step is encrypted in 8-byte segments. A set of less than 8 bytes Q′nc remains which, as in the first step, is not encrypted. The encrypted set calculated is added to the encrypted set P′c of the first step.

FIG. 12 illustrates the third and last step, reception and processing of the last segment. The method takes place in the same way. In this case, the non-useful data extracted is the padding. The set of data received to which is added the non-encrypted part Q′nc of the second step forms a set of 8-byte segments. The final result therefore represents the encryption of P and Q. This encryption takes place as the data is received rather than waiting until all the data P and Q has been received and then encrypting it all at the same time.

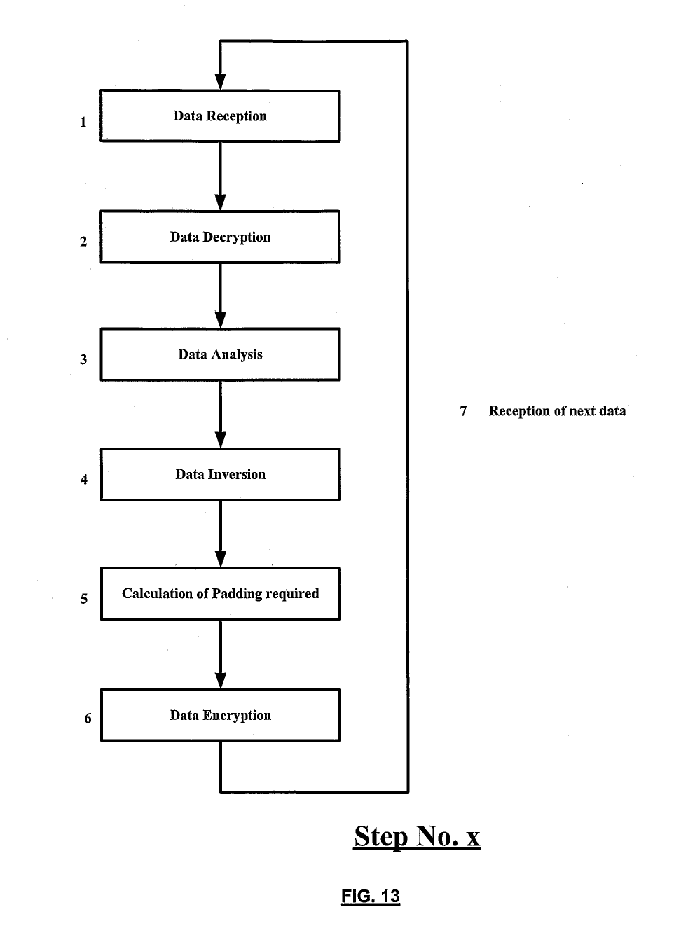

FIGS. 13 to 15 represent the various steps of the method according to the invention in another form of realisation.

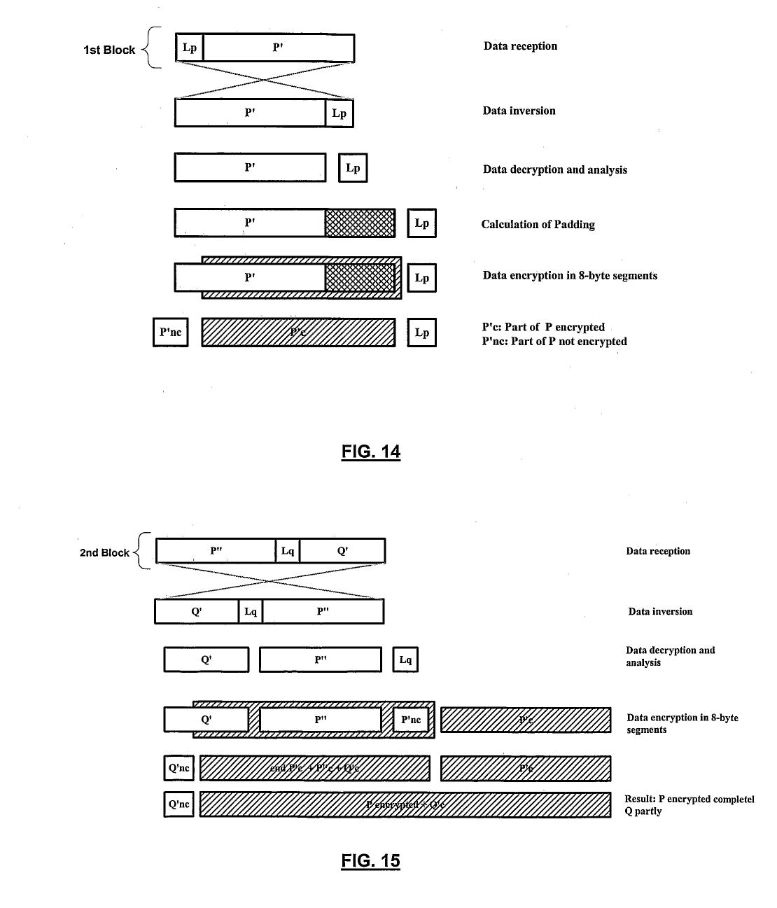

The method comprises the same steps as in the previous form of realisation, plus additional steps, data inversion and padding calculation, as illustrated on the diagram of FIG. 13. As shown on FIGS. 14 and 15 therefore, whenever a block is received, during the data processing, the data is inverted before decryption depending on the cryptographic algorithm used. Since the data is inverted, it is processed from the right to the left and padding will also have to be calculated, if necessary. If, for example, the length of the data P received, i.e. Lp, is 18 bytes and the algorithm used by the portable object can only handle data whose length is a multiple of 8 bytes, the method according to the invention adds 6 padding bytes to obtain three sections of 8 bytes. As shown on FIG. 14, if the length of data received P′ is 10 bytes, the method according to the invention isolates in P′ a set of data of 2 bytes long which it adds to 6 padding bytes to obtain a block P′c of 8 bytes and a remaining block P′nc of 6 bytes.

1-11. (canceled)

11. A method for protecting a datum, wherein the datum is encrypted and, prior to sending the datum to a recipient, the datum is divided into at least a first block and a second block, the method comprising:
receiving, at the recipient, the first block;
decrypting the first block to obtain a decrypted first block;
re-encrypting the decrypted first block to obtain a re-encrypted first block using an encryption algorithm, prior to decrypting the second block;
receiving, at the recipient, the second block;
decrypting the second block to obtain a decrypted second block; and
re-encrypting the decrypted second block to obtain a re-encrypted second block using the encryption algorithm,
wherein the first block and the second block are transmitted individually to the recipient.

12. The method of claim 11, further comprising:
analyzing the decrypted first block to determine whether the decrypted first block comprises a first non-useful datum;
if the decrypted first block comprises the first non-useful datum:
extracting the first non-useful datum from the decrypted first block to obtain a modified decrypted first block;
re-encrypting the modified decrypted first block to obtain a modified re-encrypted first block prior to decrypting the second block, wherein the modified decrypted first block is re-encrypted instead of the decrypted first block.

13. The method of claim 12, further comprising:
analyzing the decrypted second block to determine whether the decrypted second block comprises a second non-useful datum;
if the decrypted second block comprises a second non-useful datum:
extracting the second non-useful datum from the decrypted first block to obtain a modified decrypted second block;
re-encrypting the modified decrypted second block to obtain a modified re-encrypted second modified block, wherein the modified decrypted second block is re-encrypted instead of the decrypted second block.

14. The method of claim 12, wherein the first non-useful datum comprises at least one selected from the group consisting of padding, a tag associated with the datum, a header associated with the datum, a header associated with the first block, a length associated with the decrypted first block, and a length associated with the datum.

15. The method of claim 11, further comprising:
concatenating the re-encrypted second block with the re-encrypted first block to obtain re-encrypted datum.

16. The method of claim 11, wherein the decrypted first block is segmented into a first segment and a second segment prior to being re-encrypted, wherein a length of first segment correspond is equal to a required segment size of the encryption algorithm and a length of the second segment is equal to a required segment size of the encryption algorithm.

17. The method of claim 11, wherein the recipient is a smart card.

18. A smart card configured to:
receive a first block;
decrypt the first block to obtain a decrypted first block;
re-encrypt the decrypted first block to obtain a re-encrypted first block using an encryption algorithm, prior to decrypting a second block;
receive the second block;
decrypt the second block to obtain a decrypted second block; and
re-encrypt the decrypted second block to obtain a re-encrypted second block using the encryption algorithm,
wherein a datum is encrypted and, prior to sending the datum to the smart card, the datum is divided into at least a first block and a second block, and
wherein the first block and the second block are transmitted individually to the smart card.

19. A method for protecting a datum, wherein the um is encrypted and, prior to sending the datum to a recipient, the datum is divided into at least a first block and a second block, the method comprising:
receiving, at the recipient, the first block;
decrypting the first block to obtain a decrypted first block;
segmenting the decrypted first block into a first segment and a second segment, wherein a length of the first segment is equal to a required segment size of an encryption algorithm;
re-encrypting the first segment, using the encryption algorithm, to obtain a re-encrypted first segment, prior to decrypting the second block;
re-encrypting the second segment, using the encryption algorithm, to obtain a re-encrypted second segment prior to decrypting the second block, if a length of the second segment is equal to the required segment size of the encryption algorithm;
receiving, at the recipient, the second block;
decrypting the second block to obtain a decrypted second block;
if the length of the second segment is less than the required segment size of the encryption algorithm:
combining the decrypted second block with the second segment to obtain a decrypted concatenated block; and
re-encrypting the decrypted concatenated block using the encryption algorithm;
if the length of the second segment is equal to the required segment size of the encryption algorithm:
re-encrypting the decrypted second block to obtain a re-encrypted second block using the encryption algorithm,
wherein the first block and the second block are transmitted individually to the smart card.

20. The method of claim 19, further comprising:
prior to segmenting the first decrypted block:
analyzing the decrypted first block to determine whether the decrypted first block comprises a first non-useful datum;
if the decrypted first block comprises the first non-useful datum:
extracting the first non-useful datum from the decrypted first block to obtain a modified decrypted first block;
segmenting the modified decrypted first block into a third segment and a fourth segment, wherein a length of the third segment is equal to a required segment size of the encryption algorithm, wherein the modified first decrypted block is segmented instead of the decrypted first block and wherein the third and fourth segments are generated instead of the first and second segments;
re-encrypting the third segment, using the encryption algorithm, to obtain a re-encrypted third segment prior to decrypting the second block; and
re-encrypting the fourth segment, using the encryption algorithm, to obtain a re-encrypted fourth segment prior to decrypting the second block, if a length of the fourth segment is equal to the required segment size of the encryption algorithm.

21. The method of claim 19, wherein re-encrypting the decrypted concatenated block comprises:
segmenting the decrypted concatenated block in to a third segment and fourth segment;
re-encrypting the third segment if length of the third segment is equal to the required segment size of an encryption algorithm; and
re-encrypting the fourth segment if length of the fourth segment is equal to the required segment size of an encryption algorithm.

22. A smart card configured to:
receive a first block;
decrypt the first block to obtain a decrypted first block;
segment the decrypted first block into a first segment and a second segment, wherein a length of the first segment is equal to a required segment size of an encryption algorithm;
re-encrypt the first segment, using the encryption algorithm, to obtain a re-encrypted first segment, prior to decrypting a second block;
re-encrypt the second segment, using the encryption algorithm, to obtain a re-encrypted second segment prior to decrypting the second block, if a length of the second segment is equal to the required segment size of the encryption algorithm;
receive the second block;
decrypt the second block to obtain a decrypted second block;
if the length of the second segment is less than the required segment size of the encryption algorithm:
combine the decrypted second block with the second segment to obtain a decrypted concatenated block; and
re-encrypt the decrypted concatenated block using the encryption algorithm;
if the length of the second segment is equal to the required segment size of the encryption algorithm:
re-encrypt the decrypted second block to obtain a re-encrypted second block using the encryption algorithm,
wherein a datum is encrypted and, prior to sending the datum to the smart card, the datum is divided into at least the first block and the second block, and
wherein the first block and the second block are transmitted individually to the smart card.

23. A method for protecting a datum, wherein the data is encrypted and, prior to sending the datum to a recipient, the datum is divided into at least a first block and a second block, the method comprising:
receiving, at the recipient, the first block;
inverting the first block to obtain a first inverted block;
decrypting the first inverted block to obtain a decrypted first inverted block;
determining a first amount of padding to append to the decrypted first inverted block;
appending the first amount of padding to the decrypted first inverted block to obtain a padded decrypted first inverted block;
re-encrypting the padded decrypted first inverted block to obtain a re-encrypted first inverted block using an encryption algorithm, prior to decrypting the second block;
receiving, at the recipient, the second block;
inverting the second block to obtain an inverted block;
decrypting the second inverted block to obtain a decrypted second inverted block; and
re-encrypting the decrypted second inverted block to obtain a re-encrypted second inverted block using the encryption algorithm,
wherein the first block and the second block are transmitted individually to the recipient.

24. The method of claim 23, further comprising:
analyzing the decrypted first inverted block to determine whether the decrypted first inverted block comprises a first non-useful datum;
if the decrypted first inverted block comprises the first non-useful datum:
extracting the first non-useful datum from the decrypted first inverted block to obtain a modified decrypted first inverted block;
re-encrypting the modified decrypted first inverted block to obtain a re-encrypted first inverted block prior to decrypting the second block, wherein the modified decrypted first inverted block is re-encrypted instead of the decrypted first inverted block.

25. The method of claim 23, further comprising:
pre-pending the re-encrypted second inverted block to the re-encrypted first inverted block.

26. A smart card configured to:
receive a first block;
invert the first block to obtain a first inverted block;
decrypt the first inverted block to obtain a decrypted first inverted block;
determine a first amount of padding to append to the decrypted first inverted block;
append the first amount of padding to the decrypted first inverted block to obtain a padded decrypted first inverted block;
re-encrypt the padded decrypted first inverted block to obtain a re-encrypted first inverted block using an encryption algorithm, prior to decrypting a second block;
receive the second block;
invert the second block to obtain an inverted block;
decrypt the second inverted block to obtain a decrypted second inverted block; and
re-encrypt the decrypted second inverted block to obtain a re-encrypted second inverted block using the encryption algorithm,
wherein a datum is encrypted and, prior to sending the datum to the smart card, the datum is divided into at least the first block and the second block, and
wherein the first block and the second block are transmitted individually to the smart card.

27. A method for protecting the datum, wherein the datum is encrypted and, prior to sending the datum to a recipient, the datum is divided into at least a first block and a second block, the method comprising:
receiving, at the recipient, the first block;
inverting the first block to obtain a first inverted block;
decrypting the first block to obtain a decrypted first inverted block;
segmenting the decrypted first inverted block into a first segment and a second segment, wherein a length of the first segment is equal to a required segment size of an encryption algorithm;
re-encrypting the first segment, using the encryption algorithm, to obtain a re-encrypted first segment, prior to decrypting a second inverted block;
re-encrypting the second segment, using the encryption algorithm, to obtain a re-encrypted second segment prior to decrypting a second inverted block, if a length of the second segment is equal to the required segment size of the encryption algorithm;
receiving the second block;
inverting the second block to obtain the second inverted block;
decrypting the second inverted block to obtain a decrypted second inverted block;
if the length of the second segment is less than the required segment size of the encryption algorithm:
combining the decrypted second inverted block with the second segment to obtain a decrypted concatenated block; and
re-encrypting the decrypted concatenated block using the encryption algorithm;
if the length of the second segment is equal to the required segment size of the encryption algorithm:
re-encrypting the decrypted second inverted block to obtain a re-encrypted second block using the encryption algorithm,
wherein the first block and the second block are transmitted individually to the recipient.

28. The method of claim 27, further comprising:
prior to segmenting the first decrypted inverted block:
analyzing the decrypted first inverted block to determine whether the decrypted first block comprises a non-useful datum;
if the decrypted first block comprises the non-useful datum:
extracting the non-useful datum from the decrypted first inverted block to obtain a modified decrypted first inverted block;
segmenting the modified decrypted inverted first block into a third segment and a fourth segment, wherein a length of the third segment is equal to a required segment size of the encryption algorithm, wherein the modified first decrypted block is segmented instead of the decrypted first inverted block and wherein the third and fourth segments are generated instead of the first and second segments;
re-encrypting the third segment, using the encryption algorithm, to obtain a re-encrypted third segment prior to decrypting the second inverted block; and
re-encrypting the second segment, using the encryption algorithm, to obtain a re-encrypted fourth segment prior to decrypting the second inverted block, if a length of the fourth segment is equal to the required segment size of the encryption algorithm.

29. The method of claim 27, wherein combining the decrypted second inverted block with the second segment comprises pre-pending the decrypted second inverted block to the second segment.

30. A smart card configured to:
receive a first block;
invert the first block to obtain a first inverted block;
decrypt the first block to obtain a decrypted first inverted block;
segment the decrypted first inverted block into a first segment and a second segment, wherein a length of the first segment is equal to a required segment size of an encryption algorithm;
re-encrypt the first segment, using the encryption algorithm, to obtain a re-encrypted first segment, prior to decrypting a second inverted block;
re-encrypt the second segment, using the encryption algorithm, to obtain a re-encrypted second segment prior to decrypting a second inverted block, if a length of the second segment is equal to the required segment size of the encryption algorithm;
receive the second block;
invert the second block to obtain the second inverted block;
decrypt the second inverted block to obtain a decrypted second inverted block;
if the length of the second segment is less than the required segment size of the encryption algorithm:
combine the decrypted second inverted block with the second segment to obtain a decrypted concatenated block; and
re-encrypt the decrypted concatenated block using the encryption algorithm;
if the length of the second segment is equal to the required segment size of the encryption algorithm:
re-encrypt the decrypted second inverted block to obtain a re-encrypted second block using the encryption algorithm,
wherein a datum is encrypted and, prior to sending the datum to the smart card, the datum is divided into at least the first block and the second block, and
wherein the first block and the second block are transmitted individually to the smart card.
